(19) United States
(12) Patent Application Publication
(10) Pub. No.: US 2026/0121054 A1
(43) Pub. Date: Apr. 30, 2026

(54) BINDER COMPOSITION, NEGATIVE ELECTRODE INCLUDING BINDER COMPOSED OF THE COMPOSITION, METHOD FOR MANUFACTURING THE NEGATIVE ELECTRODE, AND ALL-SOLID-STATE BATTERY INCLUDING THE NEGATIVE ELECTRODE

(71) Applicants: HYUNDAI MOTOR COMPANY, Seoul (KR); KIA CORPORATION, Seoul (KR); IUCF-HYU (Industry-University Cooperation Foundation Hanyang University), Seoul (KR)

(72) Inventors: Ga Hyeon Lm, Hwaseong-si (KR); Yoon Kwang Lee, Hwaseong-si (KR); Kyu Joon Lee, Hwaseong-si (KR); So Young Lee, Hwaseong-si (KR); Yun Sung Kim, Hwaseong-si (KR); Han Jo Lee, Hwaseong-si (KR); Dong Won Kim, Seoul (KR); Young Jun Lee, Seoul (KR); Yong Han Jo, Seoul (KR)

(73) Assignees: HYUNDAI MOTOR COMPANY, Seoul (KR); KIA CORPORATION, Seoul (KR); IUCF-HYU (Industry-University Cooperation Foundation Hanyang University), Seoul (KR)

(21) Appl. No.: 19/175,362

(22) Filed: Apr. 10, 2025

(30) Foreign Application Priority Data
Oct. 25, 2024 (KR) 10-2024-0147813

(51) Int. Cl. H01M 4/62; C08C 19/28; C09D 4/06; C09D 5/24; C09D 7/20; C09D 115/00; H01M 4/02; H01M 4/04; H01M 4/133; H01M 4/134; H01M 4/1393; H01M 4/1395

(52) U.S. Cl. CPC H01M 4/622; C08C 19/28; C09D 4/06; C09D 5/24; C09D 7/20; C09D 115/00; H01M 4/0404; H01M 4/133; H01M 4/134; H01M 4/1393; H01M 4/1395; H01M 2004/027

(57) ABSTRACT

Disclosed are a binder composition that may exhibit superior binding ability when being contained in a negative electrode, a negative electrode including a binder composed of the composition, a method for manufacturing the negative electrode, and an all-solid-state battery including the negative electrode that may exhibit superior cycle life characteristics. The binder composition includes a polymer including a reactive diene, an acrylate-based compound, and a photo-crosslink initiator. A ratio between a total number of moles of double bonds in the polymer and a total number of moles of double bonds in the acrylate-based compound is in a range of 6:4 inclusive to 9:1 inclusive.

### CROSS-REFERENCE TO RELATED APPLICATION

This application claims the benefit of priority to Korean Patent Application No. 10-2024-0147813, filed in the Korean Intellectual Property Office on Oct. 25, 2024, the entire contents of which are incorporated herein by reference.

### TECHNICAL FIELD

The present disclosure relates to a binder composition capable of exhibiting an excellent binding ability, a negative electrode including the binder composed of the composition, a method for manufacturing the negative electrode, and an all-solid-state battery including the negative electrode.

### BACKGROUND

The performance of a battery is closely related to the structural stability of the electrode. This structural stability is greatly affected by the characteristics of a polymer binder that binds an electrode material and a current collector to each other. Specifically, the active material and the conductive material constituting the electrode are fixed to the current collector via the binder. In this regard, the binder plays a role in minimizing generation of cracks and pores in the electrode that may be caused by the volume change of the active material occurring during the charge/discharge process. Therefore, the binder should maintain a binding ability of the electrode components while ensuring the long-term performance and lifespan of the electrode, and should be able to maintain low resistance in order to maintain the performance of the battery.

Currently, the binder material widely used commercially is a rubber-based class of binder such as ‘polybutadiene’. The rubber-based binder has the advantage of being effective in alleviating physical deformation of the electrode due to its excellent flexibility and mechanical strength. However, the rubber-based binder may not provide sufficient binding between the electrode components, and in such cases, physical defects such as cracks, peeling off, and pores may occur in the electrode during the charge/discharge of the battery. When these defects occur, the performance of the battery may deteriorate and its lifespan may be shortened.

Accordingly, there is a need for development of a binder material that can exhibit improved physical and functional properties such as, for example, superior binding ability compared to existing rubber-based binder materials, thereby improving the life characteristics of a battery, as well as maintaining low resistance of the battery to provide high output performance.

### SUMMARY

The present disclosure addresses the above-mentioned problems occurring in the prior art while also maintaining the advantages achieved by the state of the art.

An aspect of the present disclosure provides a binder composition that may exhibit superior binding ability when being contained in a negative electrode, a negative electrode including a binder composed of the composition, a method for manufacturing the negative electrode, and an all-solid-state battery including the negative electrode that may exhibit superior cycle life characteristics.

In some specific embodiments, the present disclosure provides a binder composition comprising a polymer including a reactive diene capable of participating in a chemical reaction, an acrylate-based compound, and a photo-crosslink initiator, in which a ratio between a total number of moles of double bonds in the polymer and a total number of moles of double bonds in the acrylate-based compound is in a range of 6:4 inclusive to 9:1 inclusive. Then, under suitable conditions applied to the binder composition, the polymer and the acrylate-based compound form a three-dimensional network structure via a crosslinking reaction. Thus, when the binder is comprised in a negative electrode, the binder may exhibit an excellent binding ability.

The technical problems to be solved by the present disclosure are not limited to the aforementioned problems, and any other technical problems not explicitly identified or mentioned herein will be clearly understood to be addressed in light of the following description by those skilled in the art to which the present disclosure pertains.

In order to achieve certain technical advantages, the present disclosure provides a binder composition, a negative electrode including a binder composed of the binder composition, a method for manufacturing the negative electrode, and an all-solid-state battery including the negative electrode.
(1) In embodiments, the present disclosure provides a binder composition comprising: a polymer including a reactive diene, an acrylate-based compound, and a photo-crosslink initiator, wherein a ratio between a total number of moles of double bonds in the polymer and a total number of moles of double bonds in the acrylate-based compound is in a range of 6:4 inclusive to 9:1 inclusive.
(2) In further embodiments, the present disclosure provides the binder composition of embodiment (1), wherein the polymer is polybutadiene.
(3) In further embodiments, the present disclosure provides the binder composition of one of the embodiment (1) or (2), wherein the acrylate-based compound is butyl acrylate.
(4) In further embodiments, the present disclosure provides the binder composition of one of the embodiment (1) to (3), wherein the photo-crosslink initiator is contained in an amount of 0.5 wt % inclusive to 5 wt % inclusive, based on a combined weight of the polymer and the acrylate-based compound.
(5) In further embodiments, the present disclosure provides the binder composition of one of the embodiment (1) to (4), wherein the photo-crosslink initiator includes at least one of 2-hydroxy-2-methylpropiophenone (HMPP), 1-hydroxycyclohexyl phenyl ketone, 2-hydroxy-2-methyl-1-phenylpropan-1-one, 1-(4-(2-hydroxyethoxy)phenyl)-2-hydroxy-2-methylpropan-1-one, and/or 4-methylbenzophenone.
(6) In embodiments, the present disclosure provides a negative electrode comprising: a negative electrode current collector; and a negative electrode active material layer including: a negative electrode active material; and a binder having a three-dimensional network structure comprising a reaction product formed from a cross-linking reaction between a polymer including a reactive diene and an acrylate-based compound, wherein a ratio between a total number of moles of double bonds in the polymer and a total number of moles of double bonds in the acrylate-based compound is in a range of 6:4 inclusive to 9:1 inclusive.
(7) In further embodiments, the present disclosure provides the negative electrode of embodiment (6), wherein the negative electrode active material layer further comprises a solid electrolyte.
(8) In further embodiments, the present disclosure provides the negative electrode of embodiment (7), wherein the solid electrolyte is a sulfide-based solid electrolyte.
(9) In further embodiments, the present disclosure provides the negative electrode of one of the embodiment (7) or (8), wherein a content of the solid electrolyte is in a range of 10 wt % inclusive to 45 wt % inclusive, based on a total weight of the negative electrode active material layer.
(10) In further embodiments, the present disclosure provides an all-solid-state battery including the negative electrode of one of the embodiment (6) to (9).
(11) In some embodiments, present disclosure provides a method for manufacturing a negative electrode, the method comprising one or more steps that include: adding a polymer including a reactive diene, an acrylate-based compound, and a photo-crosslink initiator to an organic solvent to prepare a precursor solution; dispersing a negative electrode active material and a solid electrolyte in the precursor solution to prepare a slurry for a negative electrode; and coating the slurry for the negative electrode on a current collector, and photo-crosslinking the coated slurry, wherein a ratio between a total number of moles of double bonds in the polymer and a total number of moles of double bonds in the acrylate-based compound is in a range of 6:4 inclusive to 9:1 inclusive.
(12) In further embodiments, the present disclosure provides the method for manufacturing the negative electrode of the embodiment (11), wherein the organic solvent includes at least one of n-butyl butyrate, benzyl acetate, 1,4-dichlorobutane, dichlorobenzene, and/or pentyl valerate.
(13) In further embodiments, the present disclosure provides the method for manufacturing the negative electrode of one of the embodiment (11) or (12), wherein a solid content in the slurry for the negative electrode is in a range of 45 wt % inclusive to 75 wt % inclusive.
(14) In further embodiments, the present disclosure provides the method for manufacturing the negative electrode of one of the embodiment (11) to (13), wherein the photo-crosslinking is performed by using UV light.
(15) In further embodiments, the present disclosure provides the method for manufacturing the negative electrode of one of the embodiment (11) to (14), wherein the photo-crosslinking is performed for a time ranging from 10 minutes inclusive to 20 minutes inclusive.
(16) In further embodiments, the present disclosure provides the method for manufacturing the negative electrode of one of the embodiment (11) to (15), wherein the method further comprises drying after photo-crosslinking.

### BRIEF DESCRIPTION OF THE DRAWINGS

The above and other objects, features and advantages of the present disclosure will be more apparent from the following detailed description taken in conjunction with the accompanying drawings:

FIG. 1A depicts ¹H NMR spectra of polybutadiene, butyl acrylate, and Embodiment 1-1 to 1-4 before photo-crosslinking;

FIGS. 1B and 1C depict ¹H NMR spectra of polybutadiene, butyl acrylate, and Embodiment 1-1 to 1-4 after photo-crosslinking;

FIG. 1D depicts a structure of each of polybutadiene and butyl acrylate.

FIG. 2A depicts a structure after photo-crosslinking of polybutadiene and butyl acrylate;

FIG. 2B depicts ¹H NMR spectra of Embodiment 1-1 to 1-4, polybutadiene, Comparative Example 2, and polybutyl acrylate in accordance with example embodiments of the present disclosure;

FIG. 3 depicts a result of a nano scratch experiment of a negative electrode according to each of Embodiment 2-1 to 2-4 and Comparative Example 1 in accordance with example embodiments of the present disclosure;

FIGS. 4A and 4B are diagrams illustrating voltage and resistance characteristics of a battery using each of Embodiment 2-1 to 2-4 and Comparative Example 1 in accordance with example embodiments of the present disclosure;

FIGS. 4C and 4D are diagrams illustrating voltage and resistance characteristics of a battery using each of Embodiment 2-3 and Comparative Example 2 in accordance with example embodiments of the present disclosure;

FIG. 5A is a diagram illustrating life characteristics of a battery using each of Embodiment 2-1 to 2-4 and Comparative Example 1 in accordance with example embodiments of the present disclosure; and

FIG. 5B is a diagram illustrating life characteristics of a battery using each of Embodiment 2-3 and Comparative Example 2 in accordance with example embodiments of the present disclosure.

### DETAILED DESCRIPTION

Hereinafter, the present disclosure will be described in more detail.

Terms or words used in this specification and claims should not necessarily be interpreted as limited to their usual or dictionary meanings. Rather, terms as used herein should be interpreted to refer to meanings and concepts that comply with the technical ideas of the present disclosure based on the principle that the inventor may have more appropriately defined the concept of the term in order to explain the disclosure more clearly. It should also be appreciated that the use of the term “comprising”, “containing”, “including”, “having”, and similar terms, should be considered open, and not limited to the members of the exemplary lists that follow those terms. Further, it should be appreciated that those terms are also inclusive of embodiments that are closed (i.e., “consisting of”) and can be limited to the members of the listed component(s).

### Binder Composition

In an aspect, the present disclosure provides a binder composition comprising a polymer including a reactive diene, an acrylate-based compound, and a photo-crosslink initiator, wherein a ratio between a total number of moles of double bonds in the polymer and a total number of moles of double bonds in the acrylate-based compound is in a range of 6:4 inclusive to 9:1 inclusive.

Hereinafter, components of the binder composition of the present disclosure are described in detail.

In embodiments, the polymer including the reactive diene of the present disclosure comprises at least of polybutadiene, polyisoprene, styrene-butadiene rubber (SBR), nitrile butadiene rubber (NBR), ethylene-propylene-diene monomer rubber (EPDM), polychloroprene, polypentadiene, and/or polycyclopentadiene, and, in some preferred embodiments, may be polybutadiene.

In embodiments, the acrylate-based compound of the present disclosure comprises at least one of butyl acrylate, methyl acrylate, ethyl acrylate, propyl acrylate, isobutyl acrylate, 2-ethylhexyl acrylate, hexyl acrylate, dodecyl acrylate, isooctyl acrylate, phenyl acrylate, and/or cyclohexyl acrylate, and, in some preferred embodiments, may be butyl acrylate.

Suitably, the selection of each of the polymer including the reactive diene and the acrylate-based compound allows for a three-dimensional network structure to be formed via a chemical crosslinking reaction therebetween in a subsequent photo-crosslink process. The resulting three-dimensional network structure can provide excellent binding ability when comprising part of a battery.

In embodiments, the ratio between the total number of moles of double bonds in the polymer and the total number of moles of double bonds in the acrylate-based compound may be in a range of 6:4 inclusive to 9:1 inclusive. In some preferred embodiments, the ratio can be 6.5:3.5 or greater or, 7:3 or greater; and/or 8.5:1.5 or smaller, 8:2 or smaller or 7.5:2.5 or smaller. Embodiments wherein the ratio between the total mole numbers of double bonds between the compounds satisfies the above range, unreacted reactants and compounds may not exist after the photo-crosslink is performed, and a stable crosslinking structure can be formed. In such embodiments the binder composition may exhibit an excellent binding ability when comprising part of a negative electrode.

In embodiments, the photo-crosslink initiator of the present disclosure may include at least one of 2-Hydroxy-2-Methylpropiophenone (HMPP), 1-Hydroxycyclohexyl Phenyl Ketone, 2-Hydroxy-2-methyl-1-phenylpropan-1-one, 1-(4-(2-Hydroxyethoxy)phenyl)-2-hydroxy-2-methylpropan-1-one, and/or 4-Methylbenzophenone, and, in some preferred embodiments, may be 2-hydroxy-2-methylpropiophenone.

In embodiments, the photo-crosslink initiator may be contained in an amount of 0.5 wt % inclusive to 5 wt % inclusive based on the combined weight of the polymer and the acrylate-based compound. In some preferred embodiments, the initiator may be contained at 1 wt % or greater or 1.5 wt %; and/or 4.5 wt % or smaller, 4 wt % or smaller or 3 wt % or smaller. Embodiments wherein the content of the photo-crosslink initiator satisfies the above range, the efficiency of the photo-crosslink reaction may be maximized, the crosslinking reaction may proceed uniformly so that an evenly distributed crosslinking structure may be formed, and the absorption of light may be optimized so that side effects may be minimized.

### Negative Electrode

In an aspect, the present disclosure provides a negative electrode comprising a negative electrode current collector; and a negative electrode active material layer including a binder having a three-dimensional network structure formed via a crosslinking reaction of a polymer including a reactive diene and an acrylate-based compound, and a negative electrode active material, wherein the ratio between the total number of moles of double bonds in the polymer and the total number of moles of double bonds in the acrylate-based compound is in a range of 6:4 inclusive to 9:1 inclusive.

Hereinafter, the components of the negative electrode of the present disclosure are described in detail.

In embodiments, the negative electrode current collector of the present disclosure performs the role of collecting current so that electrons may migrate to an external circuit to the battery, and provides high electrical conductivity so that electrons may migrate quickly. The material comprising the negative electrode current collector is not particularly limited as long as the material exhibits conductivity without causing a chemical change in the battery. However, in some preferred embodiments, the material of the negative electrode current collector comprises at least one of copper, stainless steel, aluminum, nickel, titanium, calcined carbon, copper or stainless steel surface-treated with carbon, nickel, titanium, silver, and/or aluminum-cadmium alloy, and the like.

In embodiments, the negative electrode active material layer of the present disclosure comprises the binder having the three-dimensional network structure and the negative electrode active material, each in accordance with the aspects and embodiments described herein.

In embodiments, the binder may include the three-dimensional network structure formed via a crosslinking reaction of the polymer including the reactive diene and the acrylate-based compound. The three-dimensional network structure may fix negative electrode active material particles with improved binding characteristics compared to conventional binder materials known in the art.

In embodiments, the ratio between the total number of moles of double bonds in the polymer and the total number of moles of double bonds in the acrylate-based compound contained in the binder may be in a range of 6:4 inclusive to 9:1 inclusive and, in some preferred embodiments, 6.5:3.5 or greater or 7:3 or greater; and/or 8.5:1.5 or smaller, 8:2 or smaller or 7.5:2.5 or smaller. Embodiments wherein the ratio between the total numbers of the moles of double bonds of the compounds satisfies the above range, any unreacted or non-reactive compounds may not exist, and a stable cross-linking structure may be formed, providing for improved binding ability of the negative electrode.

The type of active material comprising the negative electrode is not particularly limited as long as the material is an active material that may be used for the negative electrode. However, in some preferred embodiments, the negative electrode active material may include at least one of lithium metal, graphite, silicon, silicon oxide (SiOₓ), silicon carbide (Si—Cₓ), lithium titanium oxide (LTO), graphite, and/or carbon nanotubes (CNT). In some preferred embodiments, the negative electrode active material may include silicon and graphite.

The negative electrode active material layer of the negative electrode of the present disclosure may further comprise a solid electrolyte. In embodiments, the solid electrolyte may be an inorganic solid electrolyte such as a sulfide-based solid electrolyte, an oxide-based solid electrolyte, a halide-based solid electrolyte, or a solid polymer electrolyte. In some preferred embodiments, the solid electrolyte may be a sulfide-based solid electrolyte.

The type of the sulfide-based solid electrolyte is not particularly limited as long as it is a general sulfide-based solid electrolyte. In some preferred embodiments, the sulfide-based solid electrolyte may include at least one of Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is one of Ge, Zn, or Ga), Li₂S—GeS₂, Li₂S—SiS₂—Li₃PO₄, Li₂S—SiS₂-LiₓMO_{y} (where x and y are positive numbers, and M is one of P, Si, Ge, B, Al, Ga, or In), and/or Li₁₀GeP₂S₁₂.

In embodiments, the solid electrolyte may be contained in an amount of 10 wt % inclusive to 45 wt % inclusive based on a total weight of the negative electrode active material layer, and, in some preferred embodiments, 15 wt % or greater, 17 wt % or greater, or 20 wt % or greater; and/or 40 wt % or smaller, 38 wt % or smaller, or 35 wt % or smaller. When the solid electrolyte is contained in the above range, the resulting negative electrode has excellent lithium ion conductivity, and providing a high energy density of the all-solid-state battery.

In embodiments, the negative electrode active material layer of the negative electrode of the present disclosure may further include a conductive material. In such further embodiments, the type of the conductive material is not particularly limited as long as the conductive material can improve the electrical conductivity of the negative electrode active material layer without causing a chemical change. As some non-limiting examples, the conductive material may include at least one of carbon-based materials such as natural graphite, artificial graphite, carbon black, acetylene black, Ketjen black, carbon fiber, and carbon nanotube; metal-based materials such as metal powders or metal fibers containing copper, nickel, aluminum, silver, and the like; and conductive polymers such as polyphenylene derivatives, and the like.

### All-Solid-State Battery

In another aspect, the present disclosure provides an all-solid-state battery including the negative electrode.

The all-solid-state battery may include the negative electrode in accordance with the present disclosure, a positive electrode, and a solid electrolyte layer.

In embodiments, the solid electrolyte layer may include a solid electrolyte, and the solid electrolyte may be the same as described above with reference to the solid electrolyte that may be contained in the negative electrode.

In embodiments, the positive electrode may be in a form in which a current collector is coated with a positive electrode active material layer. In embodiments, the positive electrode active material layer may include a positive electrode active material, a binder, a conductive material, and a solid electrolyte. In some embodiments, the solid electrolyte and the conductive material may be the same as described above with reference to the solid electrolyte and the conductive material that may be contained in the negative electrode. Furthermore, the type of the positive electrode active material is not particularly limited as long as the positive electrode active material may be applied to the positive electrode in a general all-solid-state battery, and may reversibly absorb and release lithium ions.

The type of a material comprising the binder that may be contained in the positive electrode is not particularly limited as long as the material may fix components materials of the positive electrode active material layer to each other. In some embodiments, the binder may be a binder composed of the binder composition as described above, or in some alternative embodiments may include at least one of polytetrafluoroethylene, polyethylene oxide, polyethyleneglycol, polyacrylonitrile, polyvinylchloride, polymethylmethacrylate, polypropyleneoxide, polyphosphazene, polysiloxane, polydimethylsiloxane, polyvinylidenefluoride, polyvinylidenefluoride-hexafluoropropylene copolymer (PVDF-HFP), polyvinylidenefluoride-chlorotrifluoroethylene copolymer (PVDF-CTFE), polyvinylidene fluoride-tetrafluoroethylene copolymer (PVDF-TFE), polyvinylidene carbonate, polyvinylpyrrolidinone, styrene-butadiene rubber, nitrile-butadiene rubber, and/or hydrogenated nitrile butadiene rubber.

### Method for Manufacturing Negative Electrode

In another aspect, the present disclosure provides a method for manufacturing a negative electrode, the method including at least one or more steps comprising: (S1) adding a polymer including a reactive diene, an acrylate-based compound, and a photo-crosslink initiator to an organic solvent to prepare a precursor solution; (S2) dispersing a negative electrode active material and a solid electrolyte in the precursor solution to prepare a slurry for a negative electrode; and/or (S3) coating the slurry for the negative electrode on a current collector and photo-crosslinking the coated slurry. In embodiments, the method comprises a ratio between the total number of moles of double bonds in the polymer and the total number of moles of double bonds in the acrylate-based compound in a range of 6:4 inclusive to 9:1 inclusive.

Hereinafter, the method for manufacturing the negative electrode of the present disclosure is described in detail.

### Step of Preparing Precursor Solution (S1)

In some embodiments of the method for manufacturing the negative electrode of the present disclosure, step S1 comprises preparing the precursor solution.

In embodiments, the precursor solution may be prepared by adding a polymer including a reactive diene, an acrylate-based compound, and a photo-crosslink initiator to an organic solvent, wherein the polymer, the acrylate-based compound, and the photo-crosslink initiator may be the same as described above with reference to the polymer, the acrylate-based compound, and the photo-crosslink initiator contained in the binder composition.

In embodiments, the organic solvent may include at least one of n-butyl butyrate, benzyl acetate, 1,4-dichlorobutane, dichlorobenzene, and/or pentyl valerate, and, in some preferred embodiments may be n-butyl butyrate. In embodiments wherein the organic solvent is appropriately selected, the reaction rate and efficiency may be improved, the stability of the reactants may be increased, and the subsequent photo-crosslink reaction of the polymer including the reactive diene and the acrylate-based compound may occur more predictably.

In embodiments, the ratio between the total number of moles of double bonds in the polymer and the total number of moles of double bonds in the acrylate-based compound may be in a range of 6:4 inclusive to 9:1 inclusive, and in some preferred embodiments 6.5:3.5 or greater or 7:3 or greater; and/or 8.5:1.5 or smaller, 8:2 or smaller or 7.5:2.5 or smaller. The ratio between the total mole numbers of double bonds in the compounds as discussed above can provide for the same benefits as described above with reference to the negative electrode.

### Negative Electrode Slurry Preparation Step (S2)

In some embodiments, the method for manufacturing the negative electrode of the present disclosure comprises the step S2 that includes preparing a slurry for a negative electrode using the precursor solution.

In embodiments, the slurry may be prepared by dispersing the negative electrode active material and the solid electrolyte in the precursor solution prepared in the step S1. In this regard, the negative electrode active material and the solid electrolyte may be the same as described above with reference to the negative electrode active material and the solid electrolyte that may be contained in the negative electrode.

In embodiments, a solid content in the slurry for the negative electrode may be in a range of 45 wt % inclusive to 75 wt % inclusive, and preferably, 50 wt % inclusive to 60 wt % inclusive. When the solid content satisfies the above range, the coating of the negative electrode slurry may be uniformly performed.

### Photo-Crosslink Step (S3)

In embodiments, the method for manufacturing the negative electrode of the present disclosure comprises the step S3 that includes manufacturing the negative electrode by coating the slurry for the negative electrode on the current collector and photo-crosslinking the coated slurry.

The coating process is not particularly limited as long as it is capable of uniformly coating the slurry on the negative electrode current collector.

In embodiments, the photo-crosslink may be a process of causing a chemical crosslinking reaction between the polymer including the reactive diene and the acrylate-based compound contained in the precursor solution to form a three-dimensional network structure. The three-dimensional network structure may improve the binding force of the negative electrode, and the battery including the negative electrode may exhibit similar resistance characteristics to that of the negative electrode while exhibiting excellent cycle characteristics compared to a conventional battery.

In embodiments, the photo-crosslink may be performed by using one selected from the group consisting of visible light, laser, LED, and UV, and in some preferred embodiments may be performed by using UV.

In embodiments, the photo-crosslink may be performed for a time of 10 minutes inclusive to 20 minutes inclusive, and in some preferred embodiments may be performed for a time of 12 minutes inclusive to 18 minutes inclusive. When the time for which the photo-crosslink is performed comprises the above range, the three-dimensional network structure may be uniformly formed, the crosslinking density may be optimized, and the compound may be prevented from being excessively cured, or the crosslinking may sufficiently occur.

In additional embodiments, the method for manufacturing the negative electrode of the present disclosure may include a drying step. The drying step is not particularly limited as long as it is a method capable of removing the residual solvent.

Hereinafter, the present disclosure will be described in more detail based on Examples. It will be appreciated that the following Examples are intended to exemplify the present disclosure, and the scope of the present disclosure is not limited by these Examples alone.

### Embodiment 1-1

A binder composition was prepared by dissolving 0.0158 g of polybutadiene (PBD) rubber, 0.0042 g of butyl acrylate (BA), and 0.0001 g of 2-hydroxy-2-methylpropiophenone (HMPP) in 0.78 g of N-butyl butyrate solvent. In this regard, a ratio of the total number of moles of double bonds in the polybutadiene and the total number of moles of double bonds in the butyl acrylate was calculated to be 9:1.

### Embodiment 1-2

A binder composition was prepared in the same manner as in the Embodiment 1-1 except that 0.0126 g of polybutadiene rubber, 0.0074 g of butyl acrylate, and 0.0003 g of 2-hydroxy-2-methylpropiophenone were used and the ratio of the total number of moles of double bonds in polybutadiene and the total number of moles of double bonds in butyl acrylate was calculated to be 8:2, compared to the Embodiment 1-1.

### Embodiment 1-3

A binder composition was prepared in the same manner as in the Embodiment 1-1 except that 0.010 g of polybutadiene rubber, 0.010 g of butyl acrylate, and 0.0004 g of 2-hydroxy-2-methylpropiophenone were used and the ratio of the total number of moles of double bonds in polybutadiene and the total number of moles of double bonds in butyl acrylate was calculated to be 7:3, compared to the Embodiment 1-1.

### Embodiment 1-4

A binder composition was prepared in the same manner as in the Embodiment 1-1 except that 0.0044 g of polybutadiene rubber, and 0.0006 g of 2-hydroxy-2-0.0156 g of butyl acrylate, methylpropiophenone were used and the ratio of the total number of moles of double bonds in polybutadiene and the total number of moles of double bonds in butyl acrylate was calculated to be 6:4, compared to the Embodiment 1-1.

### Embodiment 2-1

A slurry for a negative electrode was manufactured by dispersing a silicon-graphite composite as a negative electrode active material and an argyrodite-type sulfide-based solid electrolyte as a solid electrolyte in the binder composition prepared in the Embodiment 1-1. Thereafter, the slurry for the negative electrode was coated on a Ni current collector and was subjected to photo-crosslinking using a UV lamp for 15 minutes. Then, a thus-obtained composite negative electrode was dried in a vacuum oven at 70° C. for 12 hours to remove the solvent therefrom, thereby manufacturing a negative electrode.

### Embodiment 2-2

A negative electrode was manufactured in the same manner as in the Embodiment 2-1, except that the binder composition prepared in Embodiment 1-2 was used as the binder composition, compared to the Embodiment 2-1.

### Embodiment 2-3

A negative electrode was manufactured in the same manner as in the Embodiment 2-1, except that the binder composition prepared in Embodiment 1-3 was used as the binder composition, compared to the Embodiment 2-1.

### Embodiment 2-4

A negative electrode was manufactured in the same manner as in the Embodiment 2-1, except that the binder composition prepared in Embodiment 1-4 was used as the binder composition, compared to the Embodiment 2-1.

### Comparative Example 1

A negative electrode was manufactured in the same manner as in the Embodiment 2-1, except that polybutadiene was used alone as the binder and the photo-crosslink process was not performed, compared to the Embodiment 2-1.

### Comparative Example 2

Polybutyl acrylate was prepared by mixing butyl acrylate and 2-hydroxy-2-methylpropiophenone with each other and then photo-crosslinking the mixture. Then, the polybutyl acrylate and polybutadiene were dissolved in an N-butyl butyrate solvent to prepare a binder composition. In this regard, the content of each of the polybutadiene and polybutyl acrylate was set in the same manner as in Embodiment 2-1. Thereafter, a negative electrode was manufactured in the same manner as in Embodiment 2-1, except that the binder composition was used and the photo-crosslink process was not performed, compared to Embodiment 2-1.

### Experimental Example 1—Crosslinking Reaction of Binder and Identification of Structure Thereof

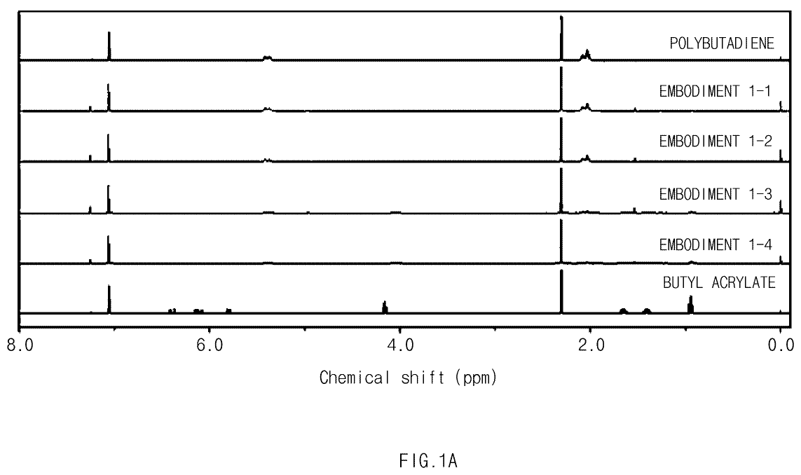

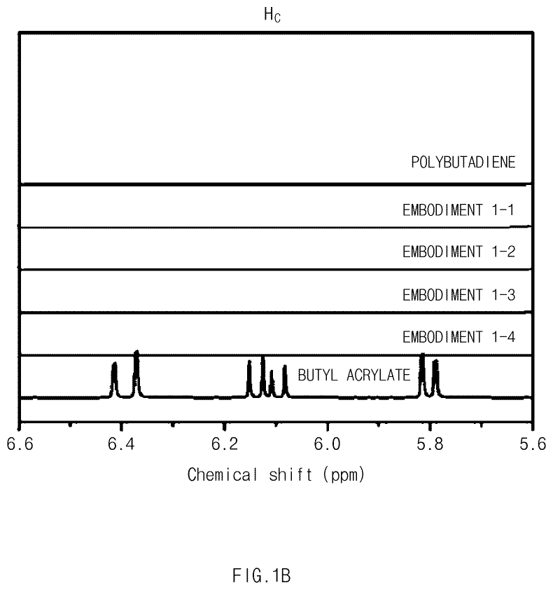

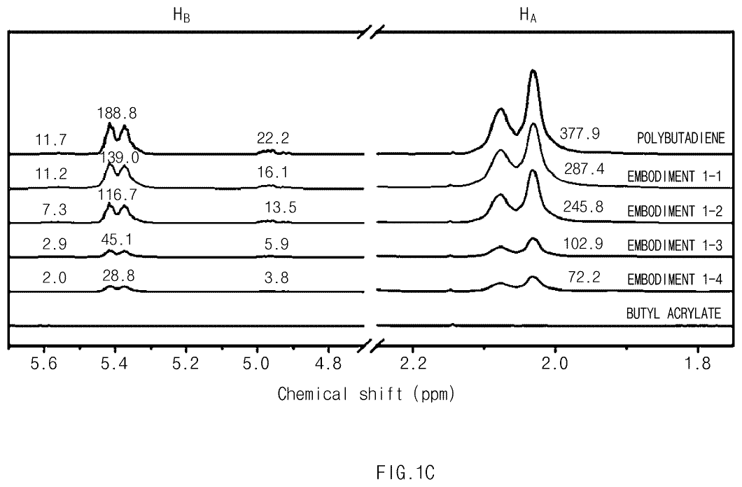

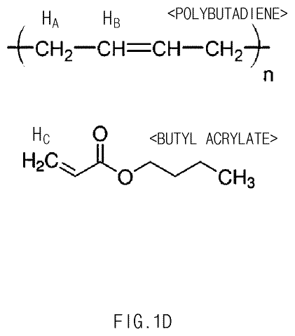

In this experiment, in order to identify whether the crosslinking reaction of polybutadiene and butyl acrylate in the binder composition obtained via each of the Embodiment 1-1 to 1-4 occurred, ¹H NMR spectra of polybutadiene and butyl acrylate before photo-crosslinking and the binder composition after photo-crosslinking are shown in FIGS. 1A, 1B, and 1C, respectively. In this regard, p-xylene was used as a reference material. Furthermore, an integral value of a 1H peak originating from the reference material was set to 100, and an integral value of peaks originating from H_{A} and H_{B} of polybutadiene were indicated as shown in Table 1 as set forth below.

TABLE 1

| | H_{B} | H_{A} | H_{B}/H_{A} |
|---|---|---|---|
| Polybutadiene | 222.7 | 377.9 | 58.9 |
| Embodiment 1-1 | 166.3 | 287.4 | 57.9 |
| Embodiment 1-2 | 137.5 | 245.8 | 55.9 |
| Embodiment 1-3 | 53.9 | 102.9 | 52.4 |
| Embodiment 1-4 | 34.6 | 72.2 | 47.9 |

As seen from FIG. 1B, it may be identified that no butyl acrylate remains in the binder composition after photo-crosslinking based on the fact that all peaks originating from H_{c} of butyl acrylate have disappeared. Furthermore, as seen from FIG. 1C and Table 1, it may be identified that as the content of butyl acrylate in the binder composition increases, the integral value of H_{B} and H_{A} decreases and a ratio of H_{B}/H_{A} decreases. Thus, it may be identified that a content of H_{B} derived from the double bonds decreases via the crosslinking reaction.

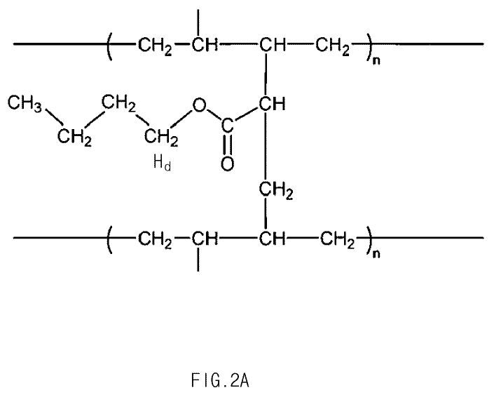

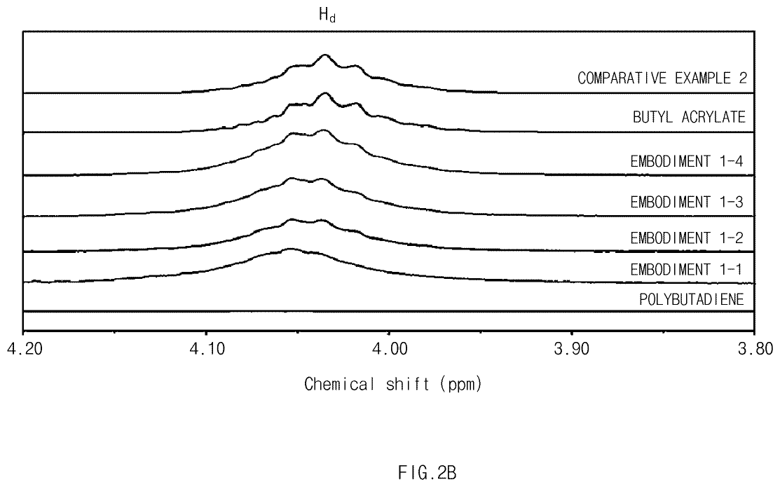

In addition, in this experiment, in order to identify the three-dimensional structure according to the crosslinking reaction, the ¹H NMR spectrum after the crosslinking reaction of the composition of each of Embodiment 1-1 to 1-4, Comparative Example 2 of the present disclosure, polybutyl acrylate, and polybutadiene was shown in FIG. 2B, and the resulting structure was shown in FIG. 2A.

As seen from FIG. 2B, it may be identified that a H_{d} peak was not observed in polybutadiene, and a H_{d} peak appears at the same position as that in the polybutyl acrylate in Comparative Example 2 in which the three-dimensional crosslinking structure is not formed. On the other hand, it may be identified that in the Embodiment, a high chemical shift occurs due to a peeling effect caused by the double bond existing in the polybutadiene in the three-dimensional cross-linked structure. Further, it may be identified that a higher chemical shift occurs as the content of polybutadiene in the binder composition increases. Thus, it may be identified that the binder according to the Embodiment has the three-dimensional cross-linked structure.

### Experimental Example 2—Evaluation of Binding Force of Negative Electrode

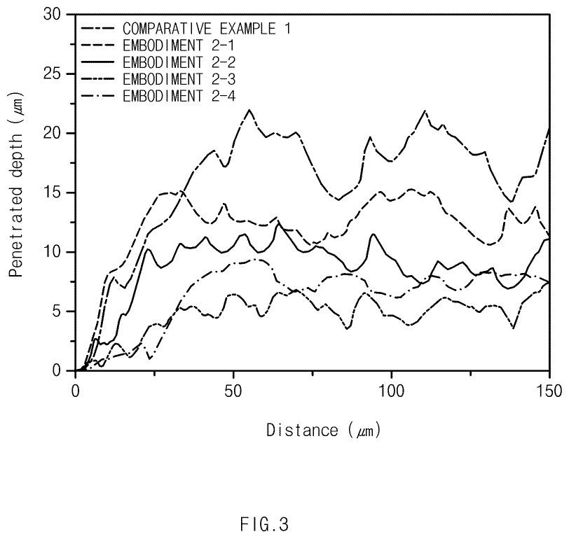

In this experiment, a nano scratch experiment was conducted to evaluate the binding force of the negative electrode according to each of Embodiment 2-1 to 2-4 and Comparative Example 1 of the present disclosure, and the result was plotted in a graph as shown in FIG. 3. Specifically, a blade of a nano scratch device moved into the negative electrode at a constant speed of 10 μm/s under a force of 0.2 m·N. In this regard, the better the binding force of the negative electrode, the smaller a penetrated depth.

As seen from FIG. 3, it may be identified that the negative electrode according to each of Embodiment 2-1 to 2-4 of the present disclosure has a smaller penetrated depth than that in the negative electrode of Comparative Example 1, thus indicating that the negative electrode using the cross-linked binder of the present disclosure achieves an excellent binding force via the three-dimensional cross-linked structure.

### Experimental Example 3—Evaluation of Internal Resistance of Negative Electrode

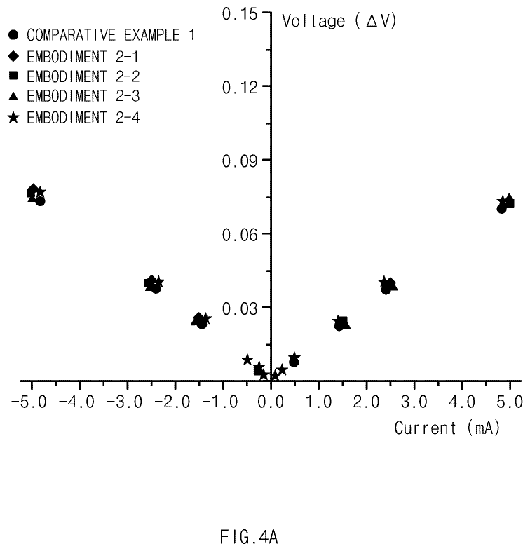

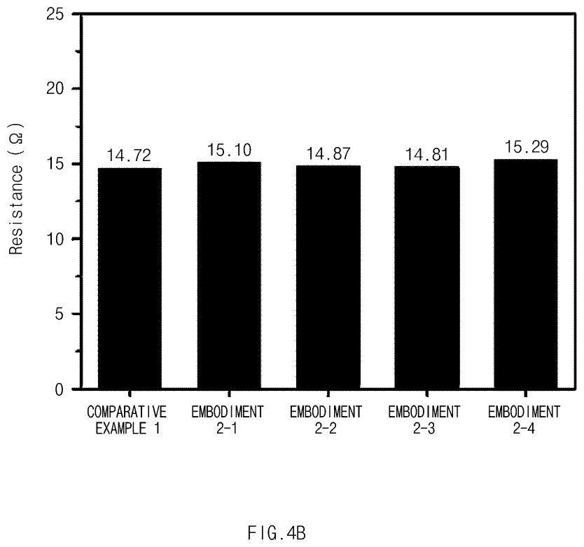

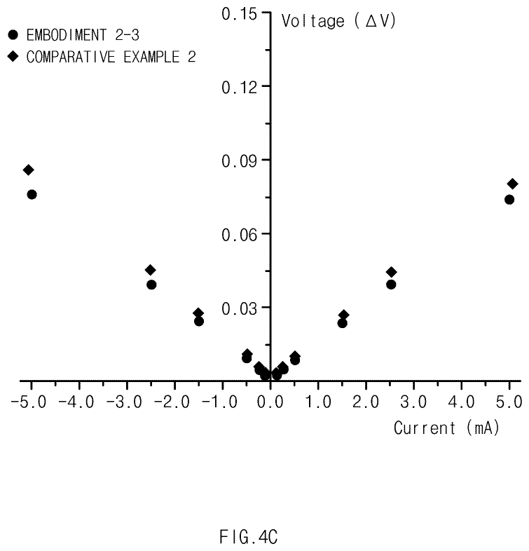

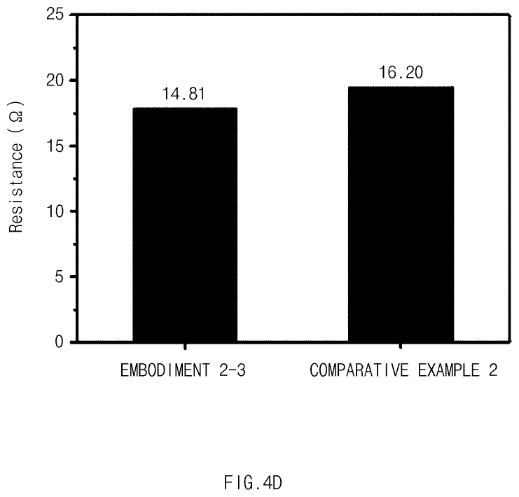

In this experiment, the internal resistance of the battery using the negative electrode of each of Embodiment 2-1 to 2-4 and Comparative Example 1 of the present disclosure was measured. Specifically, in this experiment, 150 mg of an agyrodite-type sulfide-based solid electrolyte as a solid electrolyte was put into a poly(ether ether ketone) (PEEK) mold, and then pressurized at room temperature under a pressure of 110 MPa to manufacture a solid electrolyte pellet. Then, the negative electrode of each of Embodiment 2-1 to 2-4 and Comparative Example 1 was placed into the mold and pressurized under a pressure of 450 MPa. Thereafter, lithium metal was put into the mold so as to be opposite to the solid electrolyte pellet and the pressed under a pressure of 60 MPa such that the pellet, the negative electrode, and the lithium metal are fastened to each other to manufacture a battery. Thereafter, the battery was charged/discharged once at 0.1 C to activate the battery. The battery was charged at a rate of 0.1 C to a voltage of 0.15V, and then, current was applied thereto for 10 seconds. At this time, the voltage change was measured. Thus, the resistance change of the negative electrode was plotted as a graph in FIG. 4A. Thereafter, the resistance value of the battery was calculated based on the above result, and the graph of the resistance value was plotted as FIG. 4B.

As seen from FIGS. 4A and 4B, it may be identified that the negative electrode (Comparative Example 1) in which polybutadiene was applied as the binder and the negative electrode (Embodiment 2-1 to 2-4) in which the binder of the present disclosure was applied as the binder exhibit similar resistance values. Thus, it may be identified that the crosslinked structure of the binder of the present disclosure does not cause an increase in resistance, and thus the negative electrode of the present disclosure may exhibit a similar resistance value to that of the negative electrode to which the conventional binder was applied.

In addition, in this experiment, a battery was prepared in the same manner as the above method, except that the negative electrode of each of Embodiment 2-3 and Comparative Example 2 was used. Thereafter, the battery was charged/discharged once at 0.1 C to activate the battery. The battery was charged at a rate of 0.1 C to a voltage of 0.15V, and then, current was applied thereto for 10 seconds. At this time, the voltage change was measured. The voltage change of the negative electrode was graphed in FIG. 4C, and the resistance value of the battery was graphed in FIG. 4D.

As seen from FIGS. 4C and 4D, it may be identified that the negative electrode of Embodiment 3 exhibits a smaller resistance value than that in the negative electrode of Comparative Example 2 which does not have a three-dimensional cross-linking structure. Therefore, it may be identified that the negative electrode of the present disclosure exhibits superior resistance characteristics via the cross-linking reaction of butyl acrylate and polybutadiene, compared to the negative electrode in which the cross-linking reaction does not occur.

### Experimental Example 4—Evaluation of Battery Life Characteristics

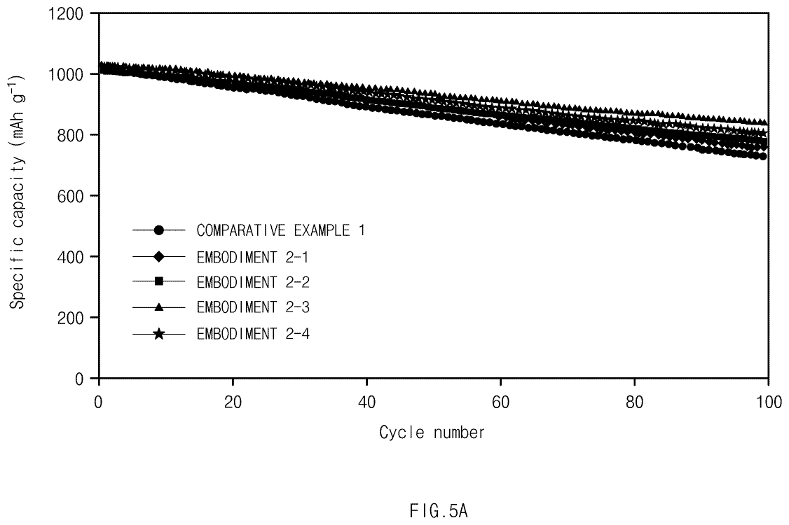

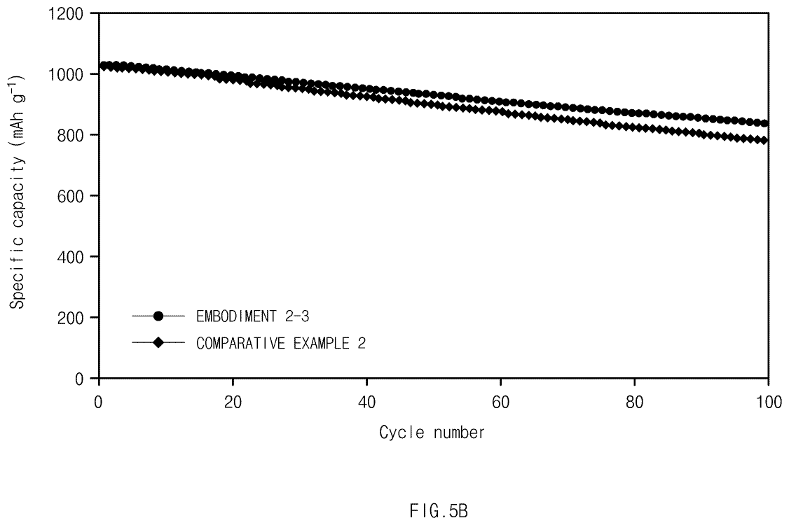

In this experiment, in order to evaluate the life characteristics of the battery prepared via each of Embodiment 2-1 to 2-4 and Comparative Example 1 of the Experimental Example 3, the discharge capacity based on the charge/discharge cycle was measured and shown in FIG. 5A. Specifically, this experiment was performed under a temperature condition of 30° C., and the charge/discharge rate was maintained at 0.3 C.

In this experiment, the capacity retention rate (CCR) after 100 cycles was specifically measured as 74.2, 75, 77.1, 81.7, and 78.4% in Comparative Example 1 and Embodiment 2-1 to 2-4, in this order, respectively. Based on the above results, it may be identified that the negative electrode according to the Embodiment exhibits a stable capacity retention rate even when the cycle is repeated, compared to the negative electrode using the conventional binder.

In addition, in this experiment, in order to evaluate the life characteristics of the battery prepared via each of Embodiment 2-3 and Comparative Example 2 of the Experimental Example 3, the discharge capacity based on the charge/discharge cycle was measured and shown in FIG. 5B. Specifically, this experiment was performed under a temperature condition of 30° C., and the charge/discharge rate was maintained at 0.3 C.

In this experiment, the capacity retention rate after 100 cycles was specifically measured as 76.7 and 81.7% in Comparative Example 2 and Embodiment 2-3, in this order, respectively. Based on the above results, it may be identified that due to the three-dimensional cross-linked structure, the negative electrode according to the Embodiment exhibits a stable capacity retention rate even when the cycle is repeated, compared to the negative electrode in which two polymers are simply mixed with each other.

The negative electrode to which the binder composed of the binder composition of the present disclosure is applied exhibits the excellent binding ability compared to a conventional negative 1 electrode, so that the life characteristics of the battery including the same may be improved while maintaining low resistance of the battery, thereby providing high output performance.

Specifically, the binder composition of the present disclosure includes the polymer including the reactive diene, the acrylate-based compound, and the photo-crosslink initiator, and thus, the three-dimensional crosslinked structure may be formed via a subsequent photo-crosslink reaction thereof. Thus, the battery to which the binder is applied may exhibit the excellent binding ability and life characteristics due to the three-dimensional network structure.

Hereinabove, although the present disclosure has been described with reference to exemplary embodiment and the accompanying drawings, the present disclosure is not limited thereto, but may be variously modified and altered by those skilled in the art to which the present disclosure pertains without departing from the spirit and scope of the present disclosure claimed in the following claims.

1. A binder composition comprising:
a polymer including a reactive diene, an acrylate-based compound, and a photo-crosslink initiator,
wherein a ratio between a total number of moles of double bonds in the polymer and a total number of moles of double bonds in the acrylate-based compound is in a range of 6:4 inclusive to 9:1 inclusive.

2. The binder composition of claim 1, wherein the polymer is polybutadiene.

3. The binder composition of claim 1, wherein the acrylate-based compound is butyl acrylate.

4. The binder composition of claim 1, wherein the photo-crosslink initiator is contained in an amount of 0.5 wt % inclusive to 5 wt % inclusive, based on a combined weight of the polymer and the acrylate-based compound.

5. The binder composition of claim 1, wherein the photo-crosslink initiator comprises at least one of 2-hydroxy-2-methylpropiophenone (HMPP), 1-hydroxycyclohexyl phenyl ketone, 2-hydroxy-2-methyl-1-phenylpropan-1-one, 1-(4-(2-hydroxyethoxy)phenyl)-2-hydroxy-2-methylpropan-1-one, or 4-methylbenzophenone.

6. A negative electrode comprising:
a negative electrode current collector; and
a negative electrode active material layer including:
a negative electrode active material; and
a binder having a three-dimensional network structure comprising a reaction product formed from a cross-linking reaction between a polymer including a reactive diene and an acrylate-based compound,
wherein a ratio between a total number of moles of double bonds in the polymer and a total number of moles of double bonds in the acrylate-based compound is in a range of 6:4 inclusive to 9:1 inclusive.

7. The negative electrode of claim 6, wherein the negative electrode active material layer further comprises a solid electrolyte.

8. The negative electrode of claim 7, wherein the solid electrolyte is a sulfide-based solid electrolyte.

9. The negative electrode of claim 7, wherein a content of the solid electrolyte is in a range of 10 wt % inclusive to 45 wt % inclusive, based on a total weight of the negative electrode active material layer.

10. An all-solid-state battery including the negative electrode of claim 6.

11. A method for manufacturing a negative electrode, the method comprising:
adding a polymer including a reactive diene, an acrylate-based compound, and a photo-crosslink initiator to an organic solvent to prepare a precursor solution;
dispersing a negative electrode active material and a solid electrolyte in the precursor solution to prepare a slurry for the negative electrode; and
coating the slurry for the negative electrode on a current collector, and photo-crosslinking the coated slurry,
wherein a ratio between a total number of moles of double bonds in the polymer and a total number of moles of double bonds in the acrylate-based compound is in a range of 6:4 inclusive to 9:1 inclusive.

12. The method for manufacturing the negative electrode of claim 11, wherein the organic solvent comprises at least one of n-butyl butyrate, benzyl acetate, 1,4-dichlorobutane, dichlorobenzene, or pentyl valerate.

13. The method for manufacturing the negative electrode of claim 11, wherein a solid content in the slurry for the negative electrode is in a range of 45 wt % inclusive to 75 wt % inclusive.

14. The method for manufacturing the negative electrode of claim 11, wherein the photo-crosslinking is performed by using UV.

15. The method for manufacturing the negative electrode of claim 11, wherein the photo-crosslinking is performed for a time in a range of 10 minutes inclusive to 20 minutes inclusive.

16. The method for manufacturing the negative electrode of claim 11, wherein the method further comprises drying after the photo-crosslinking.

17. An all-solid-state battery including the negative electrode of claim 7.

18. An all-solid-state battery including the negative electrode of claim 8.

19. An all-solid-state battery including the negative electrode of claim 9.
